(19) United States
(12) Patent Application Publication
(10) Pub. No.: US 2011/0081156 A1
(43) Pub. Date: Apr. 7, 2011

(54) IMAGE FORMING APPARATUS AND FUSER UNIT

(75) Inventors: Satoshi Kinouchi, Tokyo-to (JP); Toshihiro Sone, Kanagawa-ken (JP); Ryota Saeki, Shizuoka-ken (JP); Koji Tanimoto, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/874,486

(22) Filed: Sep. 2, 2010

Related U.S. Application Data
(60) Provisional application No. 61/248,606, filed on Oct. 5, 2009.

(51) Int. Cl. G03G 15/20

(52) U.S. Cl. 399/69; 399/330; 399/328

(57) ABSTRACT

According to one embodiment, a fuser including, a first endless member into which fluid, which retains heat, can flow, a second endless member configured to apply pressure to the first endless member, a fluid moving mechanism configured to move the fluid to the first endless member and move the fluid from the first endless member, and a heat source configured to raise temperature of the first endless member to a predetermined temperature.

### CROSS-REFERENCE TO RELATED APPLICATIONS

This application is based upon and claims the benefit of priority from: U.S. Provisional Application No. 61/248,606 filed on Oct. 5, 2009, the entire contents of each of which are incorporated herein reference.

### FILED

Embodiments described herein relates generally to an image forming apparatus and a fuser unit.

### BACKGROUND

A toner (a visualizing agent) moves to a sheet medium on the basis of image information and is integrated with the sheet medium. The sheet medium (integrated with the toner) is a hard copy.

A fuser unit integrates the toner with the sheet medium.

### BRIEF DESCRIPTION OF THE DRAWINGS

A general architecture that implements the various features of the embodiments will now be described with reference to the drawings. The drawings and the associated descriptions are provided to illustrate embodiments and not to limit the scope of the embodiments.

FIG. 1 is an exemplary diagram showing an example of an MFP (Multi-Functional Peripheral) according to an embodiment;

FIG. 2 is an exemplary diagram showing an example of a fuser of the MFP, according to an embodiment;

FIG. 3 is an exemplary diagram showing an example of a fuser of the MFP, according to an embodiment;

FIG. 4 is an exemplary diagram showing an example of a fuser of the MFP, according to an embodiment;

FIG. 5 is an exemplary diagram showing an example of a fuser of the MFP, according to an embodiment;

FIG. 6 is an exemplary diagram showing an example of a fuser of the MFP, according to an embodiment; and

FIG. 7 is an exemplary diagram showing an example of a fuser, according to an embodiment.

### DETAILED DESCRIPTION

In general, according to an embodiment, a fuser comprising: a first endless member into which fluid, which retains heat, can flow, a second endless member configured to apply pressure to the first endless member; a fluid moving mechanism configured to move the fluid to the first endless member and move the fluid from the first endless member; and a heat source configured to raise temperature of the first endless member to a predetermined temperature.

Embodiments will now be described hereinafter in detail with reference to the accompanying drawings.

An example of an embodiment is explained in detail below with reference to the accompanying drawings.

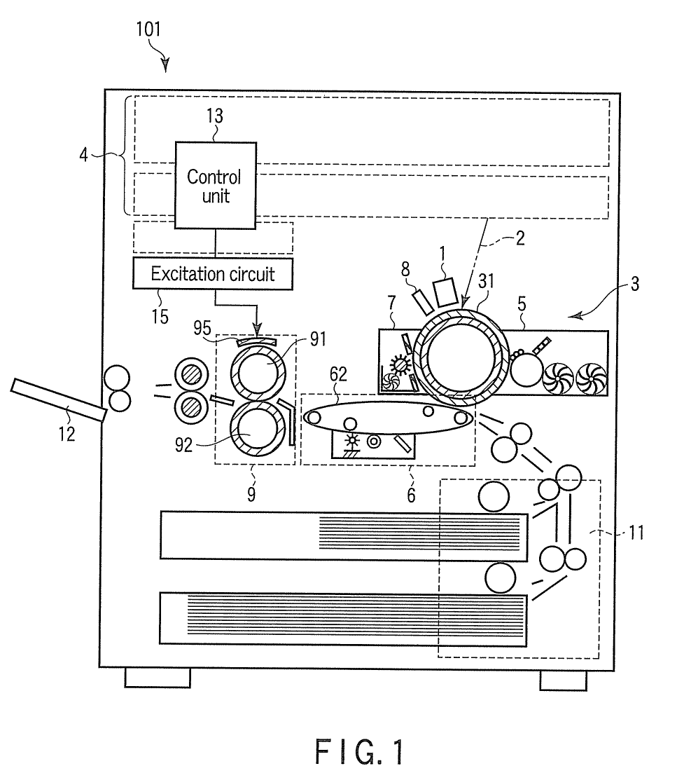

An image forming apparatus (MFP: Multi-Functional Peripheral) 101 shown in FIG. 1 includes at least a charging unit 1, a writing (exposing) unit 2, an image forming (latent image forming, developing, transferring, and cleaning) unit 3, a document reading unit 4, a developing unit 5, a transfer unit (a peeling unit) 6, a cleaning unit 7, a charge removing unit 8, and a fixing unit 9.

The charging unit 1 gives charges having predetermined polarity (in this example, “− (minus)”) to a photoconductive layer on the surface of an image bearing member, for example, a cylindrical drum 31 included in the image forming unit 3 explained below. The image bearing member is not limited to the cylindrical drum and may be an endless belt or a cylindrical drum member located on the inner side of the endless belt. The writing (exposing) unit 2 irradiates exposure light, for example, a laser beam, light intensity of which changes according to image information as a target of image formation, on the photoconductive layer on the surface of the cylindrical drum (hereinafter referred to as photoconductive drum) 31 charged by the charging unit 1 and changes the potential of the photoconductive layer. A latent image is formed in a section where the potential is changed. The image information is provided by the document reading unit 4 explained below or an external apparatus such as a PC (Personal Computer) or a facsimile. The photoconductive drum 31 has an external diameter of, for example, 100 mm and includes a photoconductive layer 33 on the surface of a metal substrate (hollow aluminum) 32 as indicated by an example shown in FIG. 3. The photoconductive layer includes, for example, an organic photoconductive member (OPC).

The image forming (latent image forming, developing, transferring, and cleaning) unit 3 conveys a toner image obtained by developing (visualizing) the latent image with toner (a visualizing agent) provided by the developing device 5 to the transfer unit 6, the cleaning unit 7, and the charge removing unit 8 according to the rotation of the image forming unit 3. The photoconductive drum 31 rotates, for example, clockwise (in a CW (clockwise) direction) at predetermined speed.

The document reading unit 4 includes a document reading device. The document reading device includes, for example, a CCD sensor with 600 dpi (dots per inch)/7500 pixels (a total number of pixels in a longitudinal direction thereof) and converts image information as a reflected light signal of irradiated light into an electric signal.

The developing unit 5 includes a magnet roller and a developing sleeve locates on the outer circumference of the magnet roller and rotates on the outer circumference. The magnet roller selectively provides toner, which moves on the surface of the developing sleeve according to the rotation of the developing sleeve, to the latent image on the surface of the photoconductive drum 31 while magnetically attracting the toner. A space between the developing sleeve and the photoconductive drum 31 is managed by a guide roller set in contact with the surface of the photoconductive drum 31. The developing sleeve is formed of a nonmagnetic material such as stainless steel or aluminum.

The transfer unit (the peeling unit) 6 moves, with an electric field provided by a transfer roller, the toner image onto a sheet conveyed by a sheet conveying belt 62 (toners forming the toner image subjected to the electric field provided by the transfer roller move to the sheet). A peeling unit separates the toner (the toner image) and the sheet from the surface of the photoconductive drum.

In the cleaning unit 7, include a waste toner and foreign matter storing unit and stores a transfer residual toner (a waste toner), fiber pieces of a sheet, a surface coating agent, or the like scraped off by a removing mechanism such as a brush member (or a brush roller having a cylindrical brush) or a foreign matter conveyed together with the sheet.

The charge removing unit 8 resets the potential of the photoconductive layer on the surface of the image bearing member 31 to an initial state before the charging by the charging unit 1 (removes residual charges on the photoconductive member). The charge removing unit 8 includes an LED array in which LED elements configured to output red light having wavelength longer than, for example, 770 nm are arranged in an axis direction of the drum 31.

The image forming apparatus 101 further includes a paper feeding unit 11 configured to feed a sheet to the transfer unit 6 of the image forming unit 3 and a paper discharge unit 12 configured to receive a sheet on which a toner image is fixed by the fixing unit 9. The image forming apparatus 101 forms a toner image corresponding to image information provided by the document reading unit 4 or an apparatus such as a PC (Personal Computer) or a facsimile.

Specifically, when image formation is instructed from an operation unit or an external apparatus not shown in the figure, process control by the image forming unit 3 and fixing temperature control by the fixing unit 9 are started according to the control by the control unit 13. A copy output or a printout (a print output) is output by, for example, latent image formation, development, transfer, and cleaning in the image forming unit 3, movement of the toner image to the sheet from the paper feeding unit 11 by the transfer and peeling unit 6, and sheet conveyance control according to image information input by the document reading unit 4 or the external apparatus.

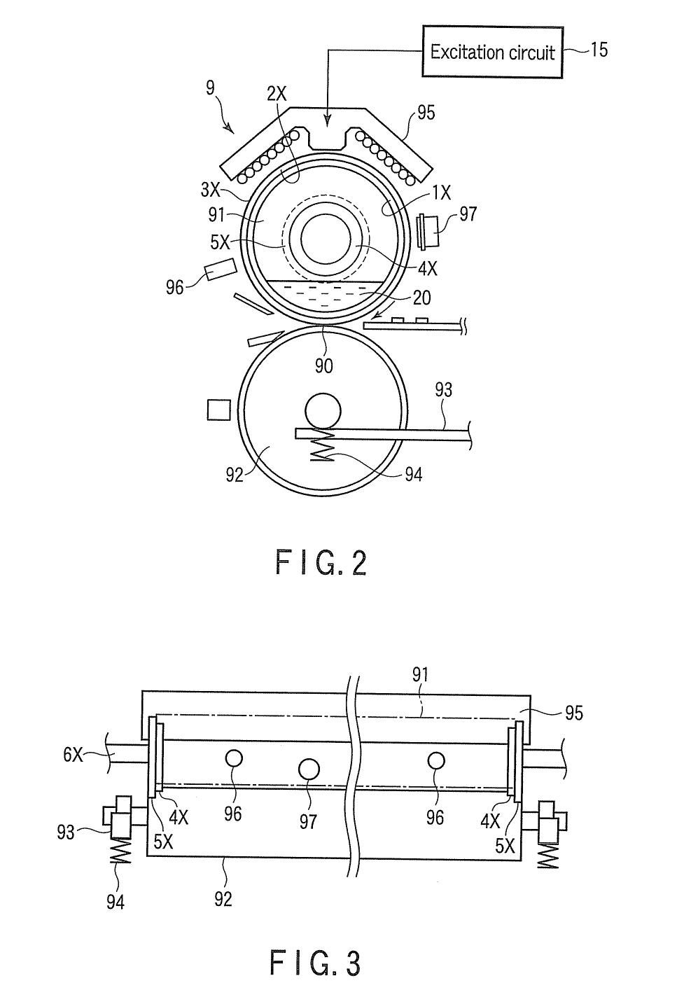

As indicated by an example shown in FIG. 2, the fuser unit 9 includes a first roller 91 (e.g., φ40 mm) and a second roller 92 (e.g., φ40 mm) configured to provide a nip section 90 defined by both the rollers 91 and 92 that come into contact with each other. An outer circumferential surface of one of the first roller 91 and the second roller 92 is brought into contact with an outer circumferential surface of the other by a spring 94 configured to apply pressure to a roller supporting member 93 configured to support the first roller 91 or the second roller 92. The roller supporting member 93 is located in a release position for reducing the pressure between the rollers to substantially zero when an image is not output, in particular, in a sleep mode or the like.

A heating device 95 raises the temperature of the outer circumferential surface (surface temperature) of at least one of the first roller 91 and the second roller 92 to predetermined temperature (the heating device 95 heats the roller surface). The surface temperature is, for example, in a predetermined range including 160°. The surface temperature is adjusted to be within the predetermined range by temperature control conforming to a result of detection by a temperature sensor (thermistor) 96. The heating device 95 includes, for example, an induction heater (IH). When the heating device 95 is the IH, an excitation coil may be divided (two or more coils can be used). As an excitation circuit 15, readily-available various types can be used. As the heating device 95, a type for making use of radiation heat by a halogen lamp or the like can also be used.

The abnormal temperature detecting mechanism (thermostat) 97 detects that the surface temperatures of both the rollers are higher than planned temperature and it is difficult to perform the control conforming to an output of the temperature sensor 96. The abnormal temperature detecting mechanism 97 prevents a temperature rise to unexpected temperature of at least one roller or overheating (burning) of a sheet member, which moves through the nip section 90, due to abnormality of the heating device 95 or the temperature sensor 96. The abnormal temperature detecting mechanism 97 is located in a predetermined position near the temperature sensor 96 or near the outer circumferential surfaces (the circumferences) of both the rollers.

A sheet member (recording paper) carrying a toner (a recording agent) passes through the nip section 90. The toner is melted and fusion-bonded to the sheet member when the sheet member passes through the nip section 90. The nip section 90 is, for example, 8 mm on the outer circumference surfaces (the circumferences) of both the rollers.

As indicated by an example shown in FIG. 3, the temperature sensor 96 measures the surface temperature of the first roller 91 or the second roller 92 in at least one place in the longitudinal direction of the roller. Desirably, two or more of the temperature sensors 96 are located in at least two or more places (measure the surface temperatures in at least two places in the longitudinal direction of the roller). The abnormal temperature detecting mechanism 97 is located in a predetermined position near the temperature sensor 96 or near the outer circumferential surfaces (the circumferences) of both the rollers. The abnormal temperature detecting mechanism 97 detects that the surface temperature is higher than planned temperature and it is difficult to perform the control conforming to an output of the temperature sensor 96.

One of the first roller 91 and the second roller 92 is rotated in an arrow direction (shown in FIG. 2) by thrust transmitted by a motor, a gear train, or a belt. The other roller is rotated (driven) according to the rotation of the one roller that comes into contact with the other roller via the nip section 90. When at least one of the first roller 91 and the second roller 92 includes a belt member, a direction in which a belt surface of the belt member moves is the same as the direction of rotation of a rotating shaft that moves the belt surface in the arrow direction.

One of the first roller 91 and the second roller 92 functioning as the heating roller (components of which are denoted by reference signs “nX (n is an integer) for convenience of explanation) includes a cored bar (a shaft) 1X, a solid rubber layer 2X, and a release layer 3X from the inner side of the roller. For example, the shaft 1X is a hollow member (a cylinder) having a thickness of 1 mm. The solid rubber layer 2X has a thickness of 0.6 mm. The thickness of the release layer 3X is 30 μm. A material of the shaft 1X is, for example, iron (Fe). The material of the shaft 1X may be stainless steel, aluminum, an alloy (a composite material) of stainless steel and aluminum, or the like.

One of the first roller 91 and the second roller 92 functioning as the pressing roller (components of which are denoted by reference signs “nY (n is an integer) for convenience of explanation) includes, around a cored bar (a shaft) 1Y, an elastic layer 2Y of silicon rubber, fluorine rubber, or the like having a predetermined thickness. The roller used as the pressing roller receives heat from a heat source (a heating device) according to necessity. However, in this embodiment, the roller does not include the heat source.

When a sheet bearing a toner passes through the nip section (a press contact section) 90 between the first roller 91 and the second roller 92, the toner on the sheet is melted and compression-bonded to the sheet.

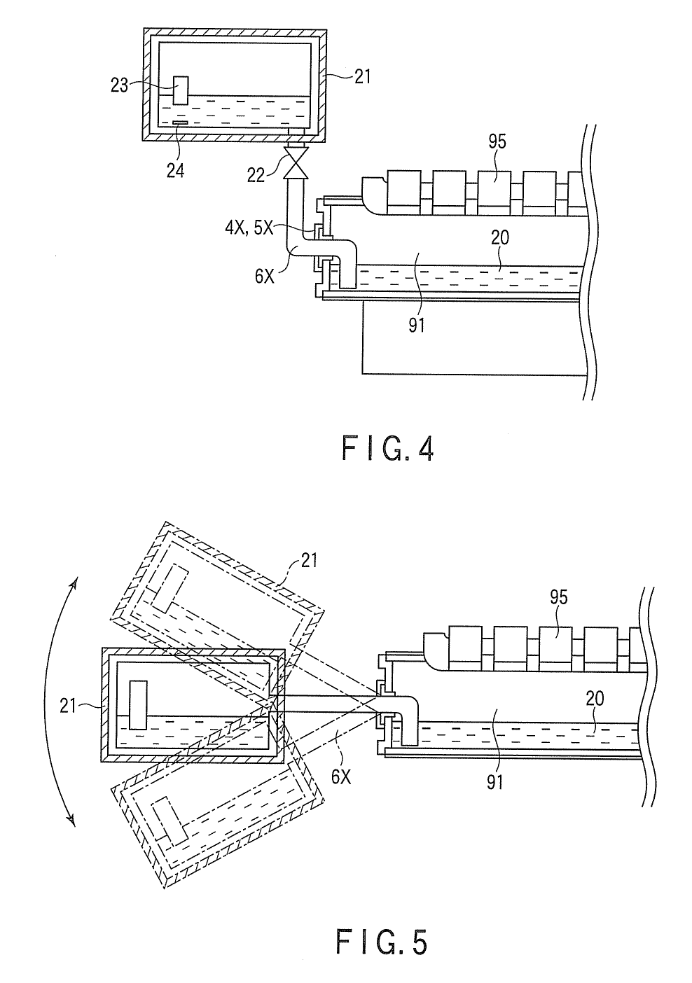

As indicated by an example shown in FIG. 4, one of the first roller 91 and the second roller 92 functioning as the heating roller desirably includes fluid (insulating oil) on the inside.

With the first roller 91 assumed as the heating roller and the second roller 92 assumed as the pressing roller, respectively, the fuser unit 9 is explained in detail below.

As explained above, for example, the heating device 95 is located on the outer circumference of the heating roller 91. In the excitation coil of the heating device 95, the number of turns of a coil member (an electric wire material) is desirably reduced by adopting a magnetic core. The shape of the coil is considered to concentrate magnetic fluxes on a predetermined position on the outer circumference of the heating roller 91. For example, it is desirable to locally concentratedly heat an upstream side in a rotating direction of the heating roller 91 with respect to the nip section 90 on the outer circumferential surface of the heating roller 91 such that heat can be provided to a sheet bearing a toner without a time difference.

In the coil of the heating device 95, a Litz wire including insulating-coated plural copper wire materials having a wire diameter of 0.5 mm is included in the coil member (the wire material). For example, nineteen φ0.5 mm wire materials coated with heat-resistant polyamideimide are bound. The influence of a skin effect in treating AC current having a high frequency can be suppressed by using the Litz wire. In other words, heat loss and the like less likely occur and AC current can be effectively used by setting a wire diameter of each of the wire materials smaller than penetration depth.

The coil of the heating device 95 generates eddy-current in the shaft 1X (in this embodiment, the cylinder) of the heating roller 91 according to an input of high-frequency current from the excitation circuit 15. A resistance component of the shaft 1X of the heating roller 91 generates Joule heat according to the action of the eddy-current. The Joule heat raises the temperature of the outer circumferential surface (and the inner side of the shaft 1X) of the heating roller 91. Therefore, the temperature of the heating roller 91 rises.

Although not explained in detail, the excitation circuit includes 15, for example, an inverter circuit. A frequency of high-frequency current output by the inverter circuit is, for example, 20 kHz to 100 kHz. The heating roller 91 generates heat equivalent to 200 W to 1.5 kW in terms of a heat quantity (or in high-frequency power indication).

As explained above, the inside of the shaft 1X of the heating roller 91 is substantially sealed (fluid-tight). Liquid (insulating oil) 20 can be stored in the shaft 1X. The fluid 20 is readily available. Heat-resistant temperature of the fluid 20 is higher than the temperature at the time of maximum rise and the maximum temperature at the time of fixing operation of the heating roller 91. The fluid 20 has heat resistance of, for example, about 300° C. A type of the fluid 20 desirably includes benzene alkyl, polybutene, or silicone oil.

The heating roller 91 includes a seal material 4X and a bearing 5X configured to seal the heating roller 91 to prevent the fluid 20 from leaking to the outside. The seal material 4X and the bearing 5X allow the rotation of the heating roller 91. The seal material 4X and the bearing 5X are connected to the inside of the heating roller 91 by a pipe member (a tube) 6X configured to enable movement (injection) of the fluid 20 to the inside of the heating roller 91 and movement (discharge) of the fluid 20 in the heating roller 91 to the outside. An insulating container 21 configured to store the fluid 20 is located near the heating roller 91. Heat insulating performance (heat retaining ability) and cost of the insulating container 21 are substantially related to each other. Therefore, the insulating container 21 can also be a heat retaining container that can maintain a predetermined temperature for a fixed time on the basis of a factor such as image forming speed (CPM) and cost of the MFP 101. An amount of the fluid 20 is desirably an amount with which the fluid 20 stays lower than the seal 4X and the bearing 5X in the center-of-gravity direction (the fluid surface does not reach the seal 4X and the bearing X5), for example, when the heating roller 91 is arranged such that the axis thereof is horizontal. In short, it is possible to minimize cost necessary for the seal 4X, the bearing 5X, and the like for sealing the fluid 20.

The pipe member (the tube) 6X can move the fluid 20 in the heating roller 91 to the insulating container 21. The pipe member (the tube) 6X can move the fluid 20 from the insulating container 21 to the inside of the heating roller 91. The movement of the fluid 20 can be easily realized by, for example, a pump 22. As the movement of the fluid 20, as indicated by an example shown in FIG. 5, free-fall caused by making use of a positional relation between the insulating container 21 and the heating roller 91 can also be used. For example, the fluid 20 can be moved to the inside of the heating roller 91 by locating the insulating container 21 in a relatively high position compared with the heating roller 91. The fluid 20 in the heating roller 91 can be moved to the insulating container 21 by locating the insulating container 21 in a relatively low position compared with the heating roller 91. The movement of the insulating container 21 can be easily realized by transmitting the driving force of a motor connected from the outside with, for example, a gear train or a pulley and a belt.

The insulating container 21 includes a temperature sensor configured to detect the temperature of the fluid 20 or an oil temperature gauge 23 that can output measured oil temperature as an electric signal. The insulating container 21 desirably includes a fluid level sensor or a residual amount detecting mechanism 24 configured to detect an amount of fluid in the insulating container 21. A control unit 13 acquires an output of the temperature sensor or the oil temperature gauge 23 and an output of the fluid level sensor or the residual amount detecting mechanism 24 and uses the outputs for temperature control explained below.

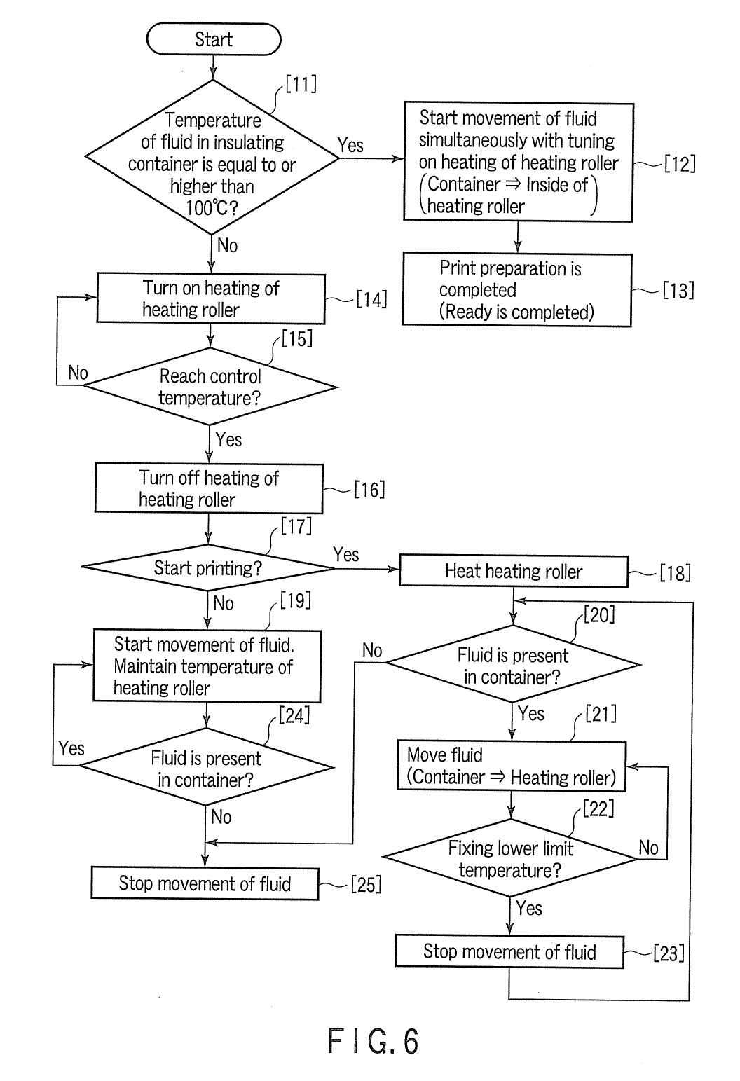

Temperature control for the fuser unit 9 is explained below with reference to FIG. 6.

When a power for the MFP 101 is turned off, the fluid 20 is located in the insulating container 21.

First, the temperature sensor or the oil temperature gauge 23 detects the temperature of the fluid 20 in the insulating container 21. Movement of the fluid 20 is different depending on the temperature of the fluid 20 and the temperature of the heating roller 91.

For example, in a state in which both the temperature of the fluid 20 and the temperature of the heating roller 91 are low, close to room temperature when, for example, the power for the MFP 101 is turned on (the opening hour of an office), the fluid 20 is kept in the insulating container 21.

Even when the power supply for the MFP 101 is turned on and the heating roller 91 is heated by the heating device 95, the fluid 20 is still kept in the insulating container 21.

If the temperature of the heating roller 91 reaches a control temperature (in this example, 160° C.), the control unit 13 detects that a ready state is reached (temperature rises) and controls the temperature of the heating roller 91 to be 160° C.

In the ready state, if there is no reserved printing (printing (image formation) is not immediately performed), the control unit 13 moves, with the pump 22, the fluid 20 in the insulating container 21 to the inside of the heating roller 91 little by little. A flow rate (an amount of movement per unit time) of the fluid 20 is set to a flow rate that does not cause a fall in the temperature of the heating roller 91.

The temperature of the fluid 20 changes into the inside of the heating roller 91 is gradually raised by thermal conduction of the heat of the heating roller 91 to finally become substantially equal to the temperature of the heating roller 91. A total amount of the fluid 20 is related to speed for moving the fluid 20 to the heating roller 91, specific heat (heat capacity) of the fluid 20, presence or absence of image formation performed, and CPM (Copy Per Minute, image forming speed). However, the total amount of the fluid 20 is desirably an amount with which the temperature of the fluid 20 rises to substantially equal to the temperature of the heating roller 91, for example, in about five minutes after the temperature of the heating roller 91 reaches the control temperature. The total amount of the fluid 20 may be an amount with which the temperature of the fluid 20 reaches the control temperature, for example, in about ten minutes.

If a printing (image forming) operation is started according to a print command or a copy command, the control unit 13 changes, according to a temperature distribution of the heating roller 91, an amount of the fluid 20 moving from the insulating container 21 to the heating roller 91.

The control unit 13 continues the movement of the fluid 20 from the insulating container 21 to the heating roller 91 until the temperature of the heating roller 91 reaches fixing lower limit temperature at which image formation can be performed. If the temperature of the heating roller 91 reaches a temperature close to the fixing lower limit temperature because of a temperature fall due to sheet (paper) passage (image formation) and a temperature fall involved in the movement of the fluid 20, the control unit 13 temporarily stops the movement of the fluid 20. In this case, the control unit 13 maintains the temperature of the heating roller 91 at temperature equal to, or lower, than the fixing lower limit temperature and does not stop the image forming operation. In this way, the control unit 13 moves and stops the fluid 20 according to the temperature of the heating roller 91. During the printing (the image formation), the heating roller 91 receives the entire fluid 20 from the insulating container 21. The temperature of the fluid 20 changes the heating roller 91 gently rises if the image forming operation is continued. The temperature of the fluid 20 in the heating roller 91 finally rises to the temperature substantially the same as the temperature of the heating roller 91.

If a predetermined time elapses after the ready or after the end of the image formation, the MFP 101 is shifted to an energy saving mode (a sleep mode) or the like according to the control by the control unit 13. The heating device 95 configured to heat the heating roller 91 is turned off. In this case, the control unit 13 returns the fluid 20 in the heating roller 91 to the insulating container 21 in preparation for a temperature fall due to heat radiation of the heating roller 91.

The temperature of the fluid 20 returned to the insulating container 21 is substantially in a state of 160° C. Although there is a slight fall in temperature in the insulating container 21, the temperature of the fluid 20 is maintained for a relatively long time. Therefore, the fluid 20 returned to the inside of the insulating container 21 can maintain a fixed heat capacity for a predetermined time.

Depending on the number of sheets to be printed (subjected to the image formation), in some case, the control unit 13 does not move the fluid 20 in the insulating container 21 to the inside of the heating roller 91. For example, if printing (image formation) of only one sheet is instructed by a print command and there is no following command, in some case, the MFP 101 shifts to the sleep mode immediately after the printing (the image formation). In this case, power consumption necessary for the movement of the fluid 20 to the heating roller 91 and collection of the fluid 20 (from the heating roller 91) for the sleep mode is, in some cases, larger than or substantially equal to power consumption for heating. Therefore, for example, if the number of sheets to be printed (subjected to image formation) instructed in a predetermined period (time) is equal to or smaller than a fixed number, the control unit 13 does not executes the movement of the fluid 20 (the number of sheets to be subjected to image formation (the number of times of image formation) may be included in conditions for movement of the fluid 20).

If the temperature of the fluid 20 in the insulating container 21 is sufficiently high, for example, equal to or higher than 100° C. and close to 160° C., when a printing (image forming) operation is started according to a print command or a copy command, the excitation circuit 15 supplies electric power having a predetermined frequency to the heating device 95 under the control by the control unit 13. Consequently, the temperature of the heating roller 91 rises. At the same time, the fluid 20 in the insulating container 21 moves to the heating roller 91. The temperature of the fluid 20 moving to the heating roller 91 is a temperature close to fixable temperature (the control temperature). Therefore, time necessary for the temperature rise of the heating roller 91 is reduced (temperature rising speed of the heating roller 91 is improved) compared with time of the temperature rise (temperature rising speed) of the heating roller 91 heated by only the heating device 95. This makes it possible to reduce warm-up time.

Specifically, as shown in FIG. 6, the control unit 13 determines whether the temperature of the fluid 20 in the insulating container 21 is equal to or higher than 100° C. If the temperature is equal to or higher than 100° C. [act 11-YES], the fluid 20 moves from the insulating container 21 to the inside of the heating roller 91 simultaneously with the start of heating of the heating roller 91 [act 12] and the MFP 101 is ready for printing (printing preparation is completed) [act 13].

On the other hand, if the temperature of the fluid 20 in the container 21 is lower than 100° C. [act 11-NO], after the start of heating of the heating roller 91 [act 14], the control unit 13 continues the heating until the temperature of the fluid 20 reaches the control temperature (160° C.). If the temperature of the fluid 20 reaches the control temperature (160° C.) [act 15-YES], the control unit 13 stops the heating of the heating roller 91 [act 16].

Following the start of the heating of the heating roller 91, if printing (image formation) is instructed (printing is started [act 17-YES]), the control unit 13 stops the movement of the fluid 20 to the heating roller 91 and heat up is started of the heating roller 91 [act 18].

If there is no instruction for printing (image formation) following the start of the heating of the heating roller 91 (printing is not started [act 17-NO]), the fluid 20 continues to move to the heating roller 91 [act 19]. If the fluid 20 is left in the insulating container 21 to the heating roller 91 is started [act 24-YES] and if the fluid 20 is absent in the insulating container 21, the movement of the fluid 20 from the insulating container 21 to the heating roller 91 is stopped [act 25], during the heating of the heating roller 91 is continued (irrespective of whether image formation (printing) is performed).

If the fluid 20 is left in the insulating container 21 (in a state, the printing is started [act 17-YES] and to start the heating of the heating roller 91) [act 20-YES], the fluid 20 moves from the container 21 to the heating roller 91 is started [act 21], on condition that the temperature of the heating roller 91 is higher than the fixing lower limit temperature [act 22-YES]. On the other hand, if the temperature of the heating roller 91 falls to the fixing lower limit temperature [act 22-NO], the movement of the fluid 20 from the insulating container 21 to the heating roller 91 temporarily stops [act 23].

In this way, when the heating by the heating device 95 is stopped, the temperature of the heating roller 91 falls in a short time because of heat radiation. Therefore, heat lost by the heat radiation is accumulated in the fluid 20, maintained in the insulating container 21 and, when image formation (printing) is instructed, the fluid 20 is moved into the heating roller 91. This makes it possible to reduce recovery (temperature rise) time during the next warm-up or during recovery from the sleep mode.

Since the temperature of the fluid 20 is equal to or higher than fixed temperature, a fall in the temperature of the heating roller 91 during paper passage (image formation) can also be suppressed. If the temperature of the heating roller 91 is the fixable temperature, a degree of heating by the heating device 95 (an output of the heating device 95) can be suppressed (reduced) and power consumption can be reduced.

As an event peculiar to the image forming apparatus (the MFP 101), in some case, a size (width) of a sheet used for image formation is small compared with the length (in a longitudinal direction along the axis) of the heating roller 91 of the fuser unit 9. For example, when effective length of the heating roller 91 is 300 mm, during image formation in which a sheet of the A4 size is conveyed such that the short side of the sheet is parallel to the axis of the heating roller 91, the width of the sheet is 210 mm. Therefore, heat generated in an area of about ⅓ of the heating role 91 is not used. When image formation under the same conditions is continued for a fixed number of sheets (fixed time), the heating roller 91 has a heat distribution in the longitudinal direction.

Therefore, the fluid 20 in the inside of the heating roller 91 is useful for uniformalizing the heat distribution of the heating roller 91. Since the fluid 20 can move in the inside of the heating roller 91, the fluid 20 receives a larger amount of heat from a portion of the heating roller 91 where temperature is high and, after heat transfer in the fluid 20 (uniformalization of heat of the fluid 20 itself by convection of the fluid 20), heats up a portion of the heating roller 91 where temperature is low (the heat of the heating roller 91 moves from the portion where temperature is high to the portion where temperature is low). In other words, according to the movement of the fluid 20 in the heating roller 91, the temperature of a coolest region of the heating roller 91 is raised. Therefore, for example, if a temperature rise in a non-paper passing section of the heating roller 91 occurs when small size sheets are continuously caused to pass, the fluid 20 acts to relax a rise in temperature at ends of the heating roller 91. In other words, it is possible to reduce the warm-up time (the recovery time) and configure a fixing device that can suppress a temperature rise in the non-paper passing section of the heating roller 91 when small size sheets are continuously caused to pass.

Under conditions in which the temperature of the heating roller 91 less easily falls below fixed temperature, for example, during duplex printing (image formation on both sides of a sheet), heat is collected (accumulated) by the fluid 20 moved to the inside of the heating roller 91. This makes it possible to maintain the temperature of the heating roller 91 within a fixed range. When an amount of heat retained by the fluid 20 (a heat capacity of the fluid 20) is large, it is also possible to weaken (reduce) heating by the heating device 95.

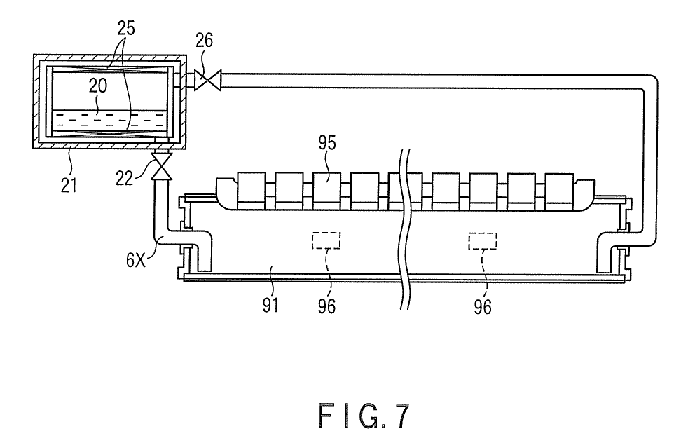

As indicated by an example shown in FIG. 7, a heater (a heat source) 25 configured to heat the fluid 20 is prepared in the inside of the insulating container 21. The fluid 20 heated by the heater 25 in advance is moved to the inside of the heating roller 91. This makes it possible to further reduce time necessary for raising the temperature of the heating roller 91 to the fixable temperature.

Specifically, the fluid 20 heated to a predetermined temperature in the insulating container 21 is moved to the inside of the heating roller 91 by the pump 26. The temperature of the heating roller 91 is raised by thermal conduction of heat retained by the fluid 20.

The fluid 20 circulates in the inside of the insulating container 21 and the inside of the heating roller 91 at fixed flow velocity.

Consequently, the temperature of the heating roller 91 is maintained constant. If image formation is continued and an amount of heat necessary for the heating roller 91 is large, the moving speed of the circulating fluid 20 is increased (an amount of movement of the fluid 20 is increased).

If an amount of heat necessary for the heating roller 91 is small, the speed of the moving fluid 20 is reduced or an amount of the moving fluid 20 is suppressed. An output of the heater 25 may be suppressed. Alternatively, both of the reduction in the speed of the moving fluid 20 or the suppression of an amount of the moving fluid 20 and the suppression of an output of the heater 25 may be used.

The temperature of the fluid 20 (electric power for heating supplied to the heater 25) and the flow rate (moving speed) of the fluid 20 are set on the basis of the temperature of the heating roller 91 detected by the temperature sensor 96.

Since the fluid 20 is heated in the inside of the insulating container 21, there is almost no loss due to heat radiation to the outside and thermal conversion efficiency is high.

Since there is internal convection of the fluid 20 itself (uniformalization of heat retained by the fluid 20 itself due to convection of the fluid 20) and the temperature of the fluid 20 (fluid temperature) is uniform, partial temperature rise or the like in the non-paper passing section of the heating roller 91 less easily occurs.

During non-image formation (during non-operation of the fixing device), the fluid 20 is also kept at (heated to) the fixed temperature in the insulating container 21. Therefore, the recovery (temperature rise) time during the next warm-up or recovery from the sleep mode can be reduced.

If the heater 25 in the insulating container 21 is insufficient as a mechanism for heating the fluid 20, when time necessary for raising the temperature of the fluid 20 to the fixable temperature is relatively long, for example, when the power supply for the MFP 101 is turned on (the MFP 101 is started), the temperature rise time can be reduced by using the heating of the heating roller 91 by the heating device 95 together with the heating by the heater 25. When the MFP 101 is started, if there is no printing (image formation) command or printing reservation, power consumption can be suppressed by stopping the heating by using the heating device 95 together with the heater 25.

As explained above, the fixing device according to the embodiment can reduce recovery time by moving heat accumulated in the fluid to the insulating container to retain the heat and using the heat during the next warm-up or during recovery.

For example, even when an image is continuously output to small-size sheets, it is possible to relax a rise in temperature that occurs in the non-paper passing section of the heating roller.

It is possible to improve heat utilization efficiency by heating the fluid in the insulating container in advance and moving the heated fluid to the inside of the heating roller to heat the heating roller with thermal conduction. In particular, it is possible to reduce time and energy (power consumption) necessary for a temperature rise (heating) to the fixable temperature by using the heating device together with the heating by the fluid.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuser comprising:
a first endless member into which fluid, which retains heat, can flow;
a second endless member configured to apply pressure to the first endless member;
a fluid moving mechanism configured to move the fluid to the first endless member and move the fluid from the first endless member; and
a heat source configured to raise temperature of the first endless member to a predetermined temperature.

2. The fuser of claim 1, wherein, if the temperature of the first endless member is lower than the predetermined temperature, the fluid moving mechanism does not move the fluid.

3. The fuser of claim 2, wherein, during non-image formation, the fluid moving mechanism moves the fluid.

4. The fuser of claim 2, wherein the fluid moving mechanism moves the fluid by an amount (a flow rate) that does not lower the temperature of the first endless member.

5. The fuser of claim 1, further comprising:
a heat retaining container configured to store the fluid, the heat retaining container being located independently from the first endless member.

6. The fuser of claim 5, wherein an amount of the fluid retained by the heat retaining container is an amount with which a horizontal-time fluid level in the first endless member is in a position lower than an inlet for the fluid.

7. The fuser of claim 2, wherein, when the temperature of the first endless member is equal to or higher than the predetermined temperature, the fluid moving mechanism moves the fluid.

8. The fuser of claim 5, wherein, when the temperature of the first endless member is equal to or higher than the predetermined temperature, the fluid moving mechanism moves the fluid from the heat retaining container to the first endless member.

9. The fuser of claim 5, wherein, when the temperature of the first endless member is equal to or higher than the predetermined temperature and a non-image formation state continues for a fixed period, the fluid moving mechanism moves the fluid from the first endless member to the heat retaining container.

10. The fuser of claim 9, wherein the heat retaining container includes an insulating container.

11. An image forming apparatus comprising:
a developing unit configured to visualize image information with a visualizing agent;
a transfer unit configured to move the visualizing agent, which visualized the image information, to a sheet; and
a fuser including a first endless member, a second endless member, a fluid moving mechanism, and a heat source, wherein
fluid, which retains heat, can flow into the first endless member,
the second endless member applies pressure to the first endless member,
the fluid moving mechanism moves the fluid to the first endless member and moves the fluid from the first endless member, and
the heat source raises temperature of the first endless member to a predetermined temperature.

12. The apparatus of claim 11, wherein, when the temperature of the first endless member is lower than the predetermined temperature, the fluid moving mechanism does not move the fluid.

13. The apparatus of claim 12, wherein, during non-image formation, the fluid moving mechanism moves the fluid.

14. The apparatus of claim 12, wherein the fluid moving mechanism moves the fluid by an amount (a flow rate) that does not lower the temperature of the first endless member.

15. The apparatus of claim 11, further comprising:
a heat retaining container configured to store the fluid, the heat retaining container being located independently from the first endless member.

16. The apparatus of claim 15, further comprising:
a heater configured to heat the fluid in the heat retaining container.

17. The apparatus of claim 16, wherein the fluid moving mechanism moves the fluid heated by the heater to the first endless member.

18. The apparatus of claim 16, wherein, when temperature of the fluid is equal to or higher than a fixed temperature, heating of the first endless member by the heat source is stopped.

19. The apparatus of claim 16, wherein, if temperature of the fluid is lower than a fixed temperature, heating of the first endless member by the heat source is used together with the heating by the heater.

20. A method of controlling temperature of a fuser, comprising:
moving, when temperature of a second endless member is raised to be equal to or higher than a predetermined temperature by heat received from a heat source, fluid to an inside of the second endless member, the second endless member receiving pressure from a first endless member; and
moving the fluid, slightly moving the fluid, or not moving the fluid to the inside of the second endless member according to an image formation state until the temperature of the second endless member is raised to the predetermined temperature by the heat received from the heat source.
